(19) United States
(12) Patent Application Publication
(10) Pub. No.: US 2013/0251251 A1
(43) Pub. Date: Sep. 26, 2013

(54) METHOD AND APPARATUS FOR INSERTING OR EXTRACTING CONCEALED INFORMATION IN OR FROM IMAGE DATA

(71) Applicants: Dmitriy DOROGOVTSEV, Kiev (UA); Sergey POMETUN, Kyiv (UA); Maksym KOSHEL, Kiev (UA); Daria RYZHYKOVA, Kiev (UA); Nikolay POLYANOVSKIY, Kiev (UA); Svitlana VOLKOVA, Kyiv (UA)

(72) Inventors: Dmitriy DOROGOVTSEV, Kiev (UA); Sergey POMETUN, Kyiv (UA); Maksym KOSHEL, Kiev (UA); Daria RYZHYKOVA, Kiev (UA); Nikolay POLYANOVSKIY, Kiev (UA); Svitlana VOLKOVA, Kyiv (UA)

(73) Assignee: SAMSUNG ELECTRONICS CO., LTD., Suwon-si (KR)

(21) Appl. No.: 13/619,372

(22) Filed: Sep. 14, 2012

(30) Foreign Application Priority Data
Mar. 22, 2012 (KR) 10-2012-0029409

(51) Int. Cl. G06K 9/46

(52) U.S. Cl. 382/165

(57) ABSTRACT

A method of inserting concealed information in image data, the method including: dividing the image data into predetermined groups; determining whether to transform at least one pixel value included in each of the predetermined groups is transformed, according to concealed information; transforming the at least one pixel value according to the determination, and inserting the concealed information in the image data depending on whether the transformed pixel value is included in a predetermined color region.

### CROSS-REFERENCE TO RELATED APPLICATION

This application claims priority from Korean Patent Application No. 10-2012-0029409, filed Mar. 22, 2012 in the Korean Intellectual Property Office, the disclosure of which is incorporated herein in its entirety by reference.

### BACKGROUND

1. Field

Methods and apparatuses consistent with exemplary embodiments relate to a method and apparatus for inserting or extracting concealed information in or from image data.

2. Description of the Related Art

Information concealment refers to concealing information by minimizing visible or audible distortion of digital data with respect to other existing digital data, such as an image, a voice, or the like. In general, information that certifies a manufacturer's right is inserted in distributed original data in order to prevent illegal reproduction or correction.

However, in existing information concealment methods, distortion of data during information concealment is severe. Thus, the quality of the data may be lowered, and concealed information cannot be easily extracted from the original data when additional information is not given.

Thus, an information concealment algorithm in which distortion of data is minimized during insertion of concealed information and concealed information is extracted with high precision without using additional information regarding data including the concealed information needs to be developed.

### SUMMARY

One or more exemplary embodiments provide a method and apparatus for inserting or extracting concealed information in or from image data depending on whether a pixel value is included in a predetermined color region.

According to an aspect of an exemplary embodiment, there is provided a method of inserting concealed information in image data, the method including: dividing the image data into predetermined groups; determining whether to transform at least one pixel value included in each of the predetermined groups, according to the concealed information; transforming the at least one pixel value according to the determination; and inserting the concealed information in the image data depending on whether the transformed pixel value is included in a predetermined color region.

The inserting the concealed information in the image data may include inserting 0 or 1 in the image data depending on whether the at least one pixel value is transformed for each of the predetermined groups.

It may be determined whether the transformed pixel value is included in the predetermined color region based on a probability that the at least on pixel value is included in the predetermined color region.

The probability that the at least on pixel value is included in the predetermined color region may be obtained using a distance between the transformed pixel value and the predetermined color region.

According to an aspect of another exemplary embodiment, there is provided a method of extracting concealed information from image data, the method including: dividing the image data into predetermined groups; and extracting concealed information according to each of the predetermined groups depending on whether a pixel value of at least one pixel value included in each of the predetermined groups from which the concealed information is to be extracted is included in a predetermined color region.

It may be determined whether the at least one pixel value is included in the predetermined color region based on a probability that the at least one pixel value is included in the predetermined color region.

The probability may be obtained based on a distance between the at least one pixel value and the predetermined color region.

The extracting the concealed information may include: inversely transforming the at least one pixel value; and extracting the concealed information for each of the predetermined groups depending on whether the at least one pixel value and the inversely-transformed pixel value are included in the predetermined color region.

The extracting the concealed information may include: obtaining a first probability that the pixel value is included in the predetermined color region and a second probability that the inversely-transformed pixel value is included in the predetermined color region for each of the predetermined groups; and extracting the concealed information for each of the predetermined groups based on a comparing of the first probability and the second probability.

The obtaining the first probability and the second probability may include obtaining the first probability and the second probability by using at least one distance between the pixel value of the at least one pixel in each of the predetermined groups or the inversely-transformed pixel value and the predetermined color region.

The obtaining the first probability and the second probability may include obtaining the first probability and the second probability by obtaining an inverse number of a sum of the at least one distance or an inverse number of a multiple obtained by multiplying the inversely-transformed pixel value by a value obtained by adding 1 to the at least one distance for each of the predetermined groups.

The extracting the concealed information may include determining whether the pixel value is transformed according to the comparing of the first probability and the second probability and extracting the concealed information for each of the predetermined groups based on the determination.

According to an aspect of another exemplary embodiment, there is provided an apparatus for inserting concealed information in image data, the apparatus including: a storage unit which stores the image data; and a controller which divides the image data into predetermined groups, determines whether to transform at least one pixel value included in each group according to concealed information, and transforms the at least one pixel value based on the determination to insert the concealed information in the image data, wherein the concealed information is inserted in the image data depending on whether the transformed pixel value is included in a predetermined color region.

The controller may include: a bit transformation module which transforms the concealed information into bit information; and a pixel value transformation module which divides the image data into the predetermined groups, determines whether to transform the at least one pixel value included in each of the predetermined groups is transformed according to the concealed information, and transforms the at least one pixel value based on the determination to insert the concealed information in the image data.

According to an aspect of another exemplary embodiment, there is provided an apparatus for extracting concealed information from image data, the apparatus including: a storage unit which stores image data; and a controller which divides the image data into predetermined groups and extracts concealed information according to each of the predetermined groups depending on whether a pixel value of at least one pixel included in each of the predetermined groups from which the concealed information is to be extracted is included in a predetermined color region.

The controller may further include a concealed information extraction module which extracts the concealed information for each of the predetermined groups depending on whether the pixel value of the at least one pixel included in each of the predetermined groups from which the concealed information is to be extracted is included in the predetermined color region.

According to an aspect of another exemplary embodiment, there is provided a computer readable recording medium having recorded thereon a program for executing a method of inserting concealed information in image data depending on whether a pixel value is included in a predetermined color region or a computer readable recording medium having recorded thereon a program for executing a method of extracting concealed information from image data depending on whether a pixel value is included in a predetermined color region.

### BRIEF DESCRIPTION OF THE DRAWINGS

The above and/or other aspects will become more apparent by describing in detail exemplary embodiments with reference to the attached drawings in which:

FIG. 1 is a block diagram of a system for inserting concealed information in image data or extracting inserted concealed information from data depending on whether a pixel value is included in a predetermined color region, according to an exemplary embodiment;

FIG. 2 is a block diagram of a structure of an apparatus for inserting concealed information to be later extracted in image data depending on whether a pixel value is included in a predetermined color region, according to an exemplary embodiment;

FIG. 3 is a block diagram of a structure of an apparatus for inserting concealed information to be later extracted in image data depending on whether a pixel value is included in a predetermined color region, according to another exemplary embodiment;

FIG. 4 is a block diagram of a structure of an apparatus for extracting concealed information inserted in image data depending on whether a pixel value is included in a predetermined color region, according to an exemplary embodiment;

FIG. 5 is a block diagram of a structure of an apparatus for extracting concealed information inserted in image data depending on whether a pixel value is included in a predetermined color region, according to another exemplary embodiment;

FIG. 6 is a flowchart illustrating a method of inserting concealed information to be later extracted in image data depending on whether a pixel value is included in a predetermined color region, according to an exemplary embodiment;

FIG. 7 is a flowchart illustrating a method of inserting concealed information to be later extracted in image data depending on whether a pixel value is included in a predetermined color region, according to another exemplary embodiment;

FIG. 8 is a flowchart illustrating a method of extracting concealed information inserted in image data depending on whether a pixel value is included in a predetermined color region, according to an exemplary embodiment; and

FIG. 9 is a flowchart illustrating a method of extracting concealed information inserted in image data depending on whether a pixel value is included in a predetermined color region, according to another exemplary embodiment.

FIG. 10 is a flowchart illustrating a method of inserting or extracting concealed information in or from image data depending on whether a pixel value is included in a predetermined color region, according to another embodiment of the present invention.

### DETAILED DESCRIPTION

The exemplary embodiments will now be described more fully with reference to the accompanying drawings, in which exemplary embodiments are shown. In the description of the exemplary embodiments and the attached drawings, if it is determined that a detailed description of commonly-used technologies or structures related to the exemplary embodiments may unnecessarily obscure the subject matter, the detailed description will be omitted. In addition, it should be noted that like elements in the drawings are represented with like reference numerals when possible.

The terms and the words used herein and in the claims should not be interpreted to be limited to a general or dictionary meaning but should be interpreted to have the meaning and concept that coincide with the technical spirit of the exemplary embodiments Thus, the exemplary embodiments and the drawings do not represent all technical spirits of the invention. Thus, it should be understood that there may be various equivalents and modifications to the exemplary embodiments.

Image data mentioned herein may include image data and video data that can be visibly output, and there is no limitation in types of data in which concealed information is inserted, in some exemplary embodiments.

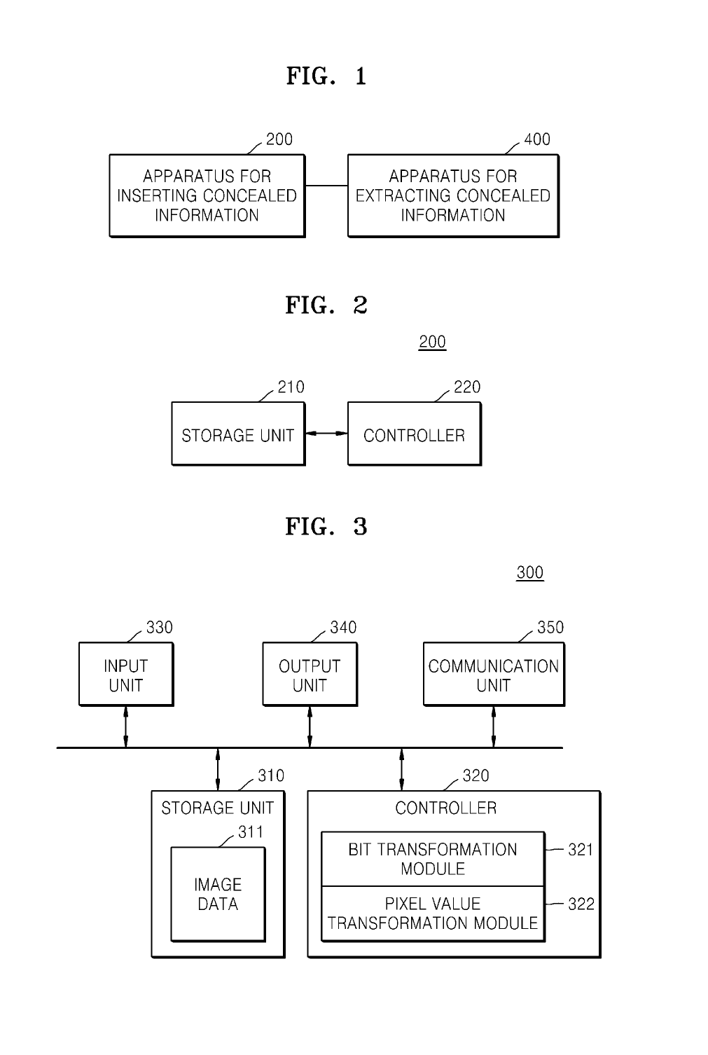

FIG. 1 is a block diagram of a system for inserting concealed information in image data or extracting inserted concealed information from image data depending on whether a pixel value is included in a predetermined color region, according to an exemplary embodiment.

Referring to FIG. 1, the system for inserting concealed information in image data or extracting inserted concealed information from image data depending on whether a pixel value is included in a predetermined color region, according to an exemplary embodiment, may include an apparatus 200 for inserting concealed information and an apparatus 400 for extracting concealed information.

The apparatus 200 for inserting concealed information inserts concealed information to be extracted later in image data depending on whether a pixel value is included in a predetermined color region.

In detail, the apparatus 200 for inserting concealed information may divide image data into groups each having a predetermined size, may determine whether to transform at least one pixel value included in a group, based on concealed information, and may transform the at least one pixel value according to the determination. In this case, the concealed information may be inserted in the image data depending on whether the transformed pixel value is included in a predetermined color region. Thus, one piece of concealed information may be inserted in each group.

According to an exemplary embodiment, the apparatus 200 for inserting concealed information may determine whether to transform a pixel value of a pixel in a group, based on concealed information. For example, the apparatus 200 for inserting concealed information may transform one or more pixel values in a group in which concealed information is to be inserted when the concealed information has a value of “1,” and the apparatus 200 for inserting concealed information may not transform any pixel value when the concealed information has a value of “0.”

A group, which is a unit in which at least one pixel value is transformed in order to insert concealed information in image data, may be a group of pictures (GOP) when the image data is video data.

A GOP refers to a set of consecutive images including at least one intra-coded picture obtained from moving picture experts group (MPEG) image processing. A GOP may include I-images, P-images, B-images, and the like and may be used as an image editing unit. In some exemplary embodiments, concealed information may be inserted in video data by transforming a pixel value of at least one pixel among several images that are included in a GOP or may be extracted by determining whether a pixel value is transformed.

In some exemplary embodiments, concealed information inserted in image data may include text information such as a character, a number, or the like, and media information including video and audio information, or the like. In this case, the concealed information may be transformed into bit information having a value of “1” or “0,” and thus the concealed information when inserted as bit information may be values of “1” or “0.” In addition, the concealed information may be any information that may be transformed into bit information. Hereinafter, for convenience, the concealed information has a value of “1” or “0” indicating that information is directly inserted in data.

In some exemplary embodiments, the apparatus 400 for extracting concealed information extracts concealed information inserted in image data depending on whether a pixel value is included in a predetermined color region, i.e., whether the pixel value is transformed, by using the image data in which the concealed information is inserted by the apparatus 200 for inserting concealed information.

In detail, the apparatus 400 for extracting concealed information may inversely transform a pixel value of at least one pixel included in a group and may extract concealed information in a group unit based on the pixel value and depending on whether the inversely-transformed pixel value is included in a predetermined color region.

Concealed information may be extracted by the apparatus 400 for extracting concealed information. The apparatus 400 obtains a probability that a pixel value may be included in a predetermined color region and a probability that the pixel value inversely-transformed may be included in the predetermined color region and compares the probabilities. In this case, the apparatus 400 for extracting concealed information may obtain the probabilities by calculating a distance between the pixel value or the inversely-transformed pixel value and the predetermined color region, which will be described below.

A pixel value of a pixel used in extracting concealed information may be a pixel value of a pixel set to be transformed when concealed information is inserted in image data. For example, when all pixel values of pixels included in a group are set to be transformed when concealed information is inserted, all the pixel values in the group may be used in extracting the concealed information. On the other hand, when a pixel value of a part selected from pixels in a group is set to be transformed, the pixel value of the pixel part set to be transformed may be used in extracting concealed information.

When a relative probability that a pixel value may be included in a predetermined color region is lower than a relative probability that the inversely-transformed pixel value may be included in the predetermined color region, it may be determined that the pixel value is transformed, and in other cases, it may be determined that the pixel value is not transformed. Thus, if it is determined that a pixel value of a pixel in a group is transformed, the apparatus 400 for extracting concealed information may extract concealed information from image data since information having a value of “1” is inserted in the image data. Also, if it is determined that the pixel value is not transformed, the apparatus 400 for extracting concealed information may not extract the concealed information from image data since information having a value of “0” is inserted in the image data.

A likelihood ratio test may be used as an operation for obtaining a probability that a pixel value may be transformed, by using at least one pixel value. The likelihood ratio test is a test method that may be used, before two models, i.e., two samples, are extracted and verified, in finding a more appropriate model between a null hypothesis, which is assumed to be true and includes ‘=’ if the null hypothesis is expressed as an equation, and an alternative hypothesis that is accepted if the null hypothesis is rejected. When a probability using a null hypothesis is equal to or higher than a probability using an alternative hypothesis, the null hypothesis may be accepted, and when the probability using the null hypothesis is lower than the probability using the alternative hypothesis, the alternative hypothesis may be accepted.

In some exemplary embodiments, when the likelihood ratio test is used, if a null hypothesis is defined to be where a pixel value is not transformed, when a probability that the inversely-transformed pixel value may be included in a predetermined color region is lower than a probability that the pixel value is included in the predetermined color region, the null hypothesis may be accepted, and it may be determined that the pixel value is not transformed.

The apparatus 200 for inserting concealed information and the apparatus 400 for extracting concealed information may be a variety of types of apparatuses, such as, personal computers (PCs), notebook computers, mobile phones, tablet PCs, navigation terminals, smart phones, personal digital assistants (PDAs), smart TVs, portable multimedia players (PMPs), and digital broadcasting receivers. These apparatuses are examples, and aspects of the exemplary embodiments are not limited to these apparatuses. The apparatus 200 for inserting concealed information and the apparatus 400 for extracting concealed information may be any communication device that has been developed and used or will be developed in the future. In addition, the apparatus 200 for inserting concealed information and the apparatus 400 for extracting concealed information may be server devices that insert information in data.

In addition, in some exemplary embodiments, information insertion and extraction are separated from each other and may be performed by different apparatuses. However, aspects of the exemplary embodiments are not limited thereto, and information insertion and information extraction may be performed by one apparatus.

The apparatus 200 for inserting concealed information and the apparatus 400 for extracting concealed information may transmit or receive data in a wired or wireless manner and may perform communication in one or more manners among Bluetooth, Zigbee, radio frequency identification (RFID), infrared data association (IrDA), ultra wideband (UWB), and local wired communication, such as a universal serial bus (USB).

In addition, the apparatus 200 for inserting concealed information and the apparatus 400 for extracting concealed information may transmit and receive data via a network. The network may be an Internet Protocol (IP) network that provides transmission and reception services of a large-capacity data service via an IP and provides a continuous data service. The network may be any IP network with an IP network structure for unifying different networks based on an IP.

In addition, the network may include one or more networks such as a wired network, a third generation (3G) mobile network including a wireless broadband (Wibro) network and WCDMA, a 3.5G mobile network including a high speed downlink packet access (HSDPA) network and a long term evolution (LTE) network, a 4G mobile network including LTE advanced, a satellite network, and a wireless local area network (LAN) including a wireless fidelity (Wi-Fi) network.

FIG. 2 is a block diagram of a structure of an apparatus 200 for inserting concealed information to be later extracted in image data depending on whether a pixel value is included in a predetermined color region, according to an exemplary embodiment.

Referring to FIG. 2, the apparatus 200 for inserting concealed information according to an exemplary embodiment may include a storage unit 210 and a controller 220.

In the exemplary embodiment, the storage unit 210 stores data required for the apparatus 200 to perform an operation for inserting concealed information or stores a related program. The storage unit 210 may store an operating system (OS) of the apparatus 200 for inserting concealed information and one or more application programs. In detail, the storage unit 210 may store image data in which concealed information is to be inserted. The storage unit 210 may include all types of storage media, such as random access memory (RAM), read only memory (ROM), a hard disk drive (HDD), flash memory, a compact disk (CD)-ROM, and a digital versatile disk (DVD).

The controller 220 controls the overall operation of apparatus 200 for inserting concealed information. The controller 220 controls the apparatus 200 for inserting concealed information to operate based on the OS stored in the storage unit 210, to constitute a basic platform environment of the apparatus 200 for inserting concealed information, and to execute the application programs according to user selection to provide an arbitrary function.

In detail, the controller 220 divides image data into predetermined groups, determines whether to transform at least one pixel value included in a group, based on concealed information, and transforms the at least one pixel value according to the determination result. In this case, the concealed information is inserted in the image data depending on whether the transformed pixel value is included in a predetermined color region. For example, when concealed information having a value of “1” is inserted in image data, a pixel value in a group may be transformed so as not to be included in a predetermined color region. Contrary to this, when concealed information having a value of “0” is inserted in image data, a pixel value in a group may not be transformed. Thus, pixel values in a group before being transformed may be included in a predetermined color region.

FIG. 3 is a block diagram of a structure of an apparatus 300 for inserting concealed information to be extracted later in image data depending on whether a pixel value is included in a predetermined color region, according to another exemplary embodiment.

Referring to FIG. 3, the apparatus 300 for inserting concealed information according to the present exemplary embodiment may include a storage unit 310, image data 311, a controller 320, an input unit 330, an output unit 340, and a communication unit 350. The storage unit 310 and the controller 320 correspond to the storage unit 210 and the controller 220 of FIG. 2, respectively, and repetitive explanations thereof are omitted.

In the exemplary embodiment, the controller 320 may include a bit transformation module 321 and a pixel value transformation module 322.

If concealed information is not bit information including a value of “0” or “1,” the bit transformation module 321 may transform the concealed information into bit information including a value of “0” or “1.” A value of “0” or “1” as the concealed information transformed into bit information by the bit transformation module 321 may be inserted in image data in a group unit.

If a pixel value of a pixel in image data is included in a predetermined color region, the pixel value transformation module 322 may transform a pixel value of at least one pixel in a group in which concealed information is to be inserted to a value not included in the predetermined color region.

When a predetermined color region is a YCbCr region and a pixel p has a value of Y, Cb, or Cr included in the YCbCr region, the pixel value transformation module 322 may transform at least one among the values of Cb and Cr of the pixel p and may insert concealed information in image data.

The YCbCr region may have about 2,600,000 values, and 8 bits per axis, totaling 24 bits, i.e., only about 15% of the YCbCr region is in the whole color space, which has 224 values. Thus, when pixel values in the YCbCr region are transformed by multiplying at least one value of the values of cb and cr by a constant or by dividing at least one value thereof by a constant, there is a great possibility that the transformed pixel values may not be included in the YCbCr region of the whole color space.

Thus, in order to insert concealed information, such as a value of “0” or “1,” depending on whether a transformed pixel value is included in a predetermined color region, a region representing a small portion of the whole color space, like the YCbCr region, may be set as the predetermined color region.

In some exemplary embodiments, a pixel value may be transformed by multiplying at least one of the values of cb and cr of the pixel p by a constant other than a value of “1.” Hereinafter, a constant used in transforming the pixel value is referred to as an insertion factor.

The insertion factor may be a value other than “1,” which, when multiplied with another value, does not transform the other value. In addition, the insertion factor may be a value that provides the greatest possibility that a pixel value in a predetermined color may not be included in the predetermined color region when the pixel value region is multiplied by the insertion factor. Thus, when the pixel value transformation module 322 transforms a pixel value in a group, the insertion factor may be obtained and set such that most pixel values in the group are not included in the predetermined color region when multiplied by the insertion factor.

In some exemplary embodiments, the reason why the pixel value transformation module 322 transforms a pixel value by transforming at least one of the values of cb and cr and not the value of y among the values of y, cb, and cr of the pixel p is that y is an element indicating brightness of an image and is the main element of image data. Thus transforming the value of cb or cr during image data processing may be more easily and quickly performed compared to transforming the value of y.

Hereinafter, an operation of transforming a pixel value according to an exemplary embodiment will be described using Equations 1 and 2.

Equation 1 indicates that the pixel values {y, cb, cr} of the pixel p in which concealed information is to be inserted are included in the YCbCr region.

p={y,cb,cr}εYCbCr [Equation 1]

Equation 2 indicates an exemplary embodiment in which a pixel value is transformed in order to insert concealed information having a value of “1” into one group.

MARK({y,cb,cr})={y,cb*k,cr}, k≠1 [Equation 2]

MARK({y,cb,cr}) indicates transformed pixel values {y,cb,cr}. The value of cb of the pixel p may be transformed into a value obtained by multiplying the value of cb with the insertion factor. In this case, the pixel value to be transformed may be at least one pixel value of a pixel in a group in which concealed information is to be inserted. In addition, an insertion factor k is a value by which a value is multiplied and transformed and thus may be a value other than “1.”

The input unit 330 is a unit for generating a user input signal for controlling or operating the apparatus 300 for inserting concealed information according to user manipulation and may be implemented via various types of input units. For example, the input unit 330 may include one or more key input units, touch input units, gesture input units, or voice input units. A key input unit that generates a signal corresponding to a key according to user manipulation may be a key pad or a keyboard. A touch input unit that senses a user touch operation to recognize an input operation may be a touch pad, a touch screen, or a touch sensor. A gesture input unit that recognizes a user operation, i.e., a designated particular operation such as an operation of shaking or moving a terminal, an operation of accessing a terminal, an eye flickering operation, or the like, using a particular input signal may include one or more terrestrial magnetic sensors, acceleration sensors, cameras, altimeters, gyro sensors, and proximity sensors.

In FIG. 3, the input unit 330 may insert concealed information by selecting the concealed information and original data in which the concealed information is to be inserted, according to user manipulation.

The output unit 340 outputs a user interface for inserting information in original data, as illustrated in FIG. 3. For example, the output unit 340 may be a liquid crystal display (LCD), a thin film transistor-liquid crystal display (TFT-LCD), a light emitting diode (LED), an organic light emitting diode (OLED), an active matrix organic light emitting diode (AMOLED), a flexible display, and a three-dimensional display.

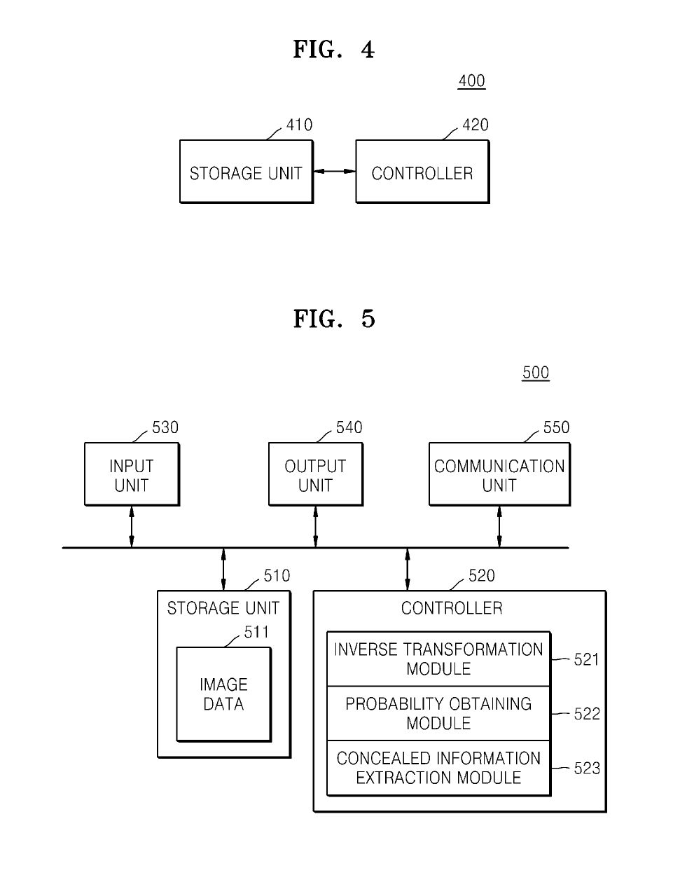

In FIG. 3, the communication unit 350 may transmit or receive data to or from an apparatus for extracting concealed information (for example, apparatus 400 of FIG. 4 or apparatus 500 of FIG. 5) via wired/wireless communication or infrared ray communication, a network, or the like.

FIG. 4 is a block diagram of a structure of an apparatus 400 for extracting concealed information inserted in image data depending on whether a pixel value is included in a predetermined color region, according to an exemplary embodiment.

Referring to FIG. 4, the apparatus 400 for extracting concealed information according to the exemplary embodiment may include a storage unit 410 and a controller 420.

In FIG. 4, the storage unit 410 stores data required for an operation of the apparatus 400 for extracting concealed information or stores a related program. Basically, the storage unit 410 may store an OS of the apparatus 400 for extracting concealed information and one or more application programs. In detail, the storage unit 410 may store image data from which concealed information is to be extracted. The storage unit 410 may include various types of storage media, such as RAM, ROM, an HDD, flash memory, a CD-ROM, and a DVD.

The controller 420 controls the overall operation of the apparatus 400 for extracting concealed information. Basically, the controller 420 controls the apparatus 400 for extracting concealed information to operate based on the OS stored in the storage unit 410, to constitute a basic platform environment of the apparatus 400 for extracting concealed information, and to execute the application programs according to user selection to provide an arbitrary function.

The controller 420 divides image data into predetermined groups and extracts concealed information from a group depending on whether at least one pixel value included in the group is included in a predetermined color region.

In detail, in order to extract concealed information inserted in a predetermined group of image data, the controller 420 inversely transforms at least one pixel value in a group and obtains a relative probability that the pixel value may be included in a predetermined color region and obtains a relative probability that the inversely-transformed pixel value may be included in the predetermined color region. The controller 420 may extract the concealed information by comparing the relative probability that the pixel value may be included in the predetermined color region and the relative probability that the inversely-transformed pixel value may be included in the predetermined color region. When the relative probability that the pixel value may be included in the predetermined color region is lower than the relative probability that the inversely-transformed pixel value may be included in the predetermined color region, it may be determined that the pixel value is transformed, and in other cases, it may be determined that the pixel value is not transformed.

FIG. 5 is a block diagram of a structure of an apparatus 500 for extracting concealed information inserted in image data depending on whether a pixel value is included in a predetermined color region, according to another exemplary embodiment.

Referring to FIG. 5, the apparatus 500 for extracting concealed information according to the exemplary embodiment may include a storage unit 510, image data 511, a controller 520, an input unit 530, an output unit 540, and a communication unit 550. The apparatus 500 for extracting concealed information illustrated in FIG. 5 may correspond to the apparatus 400 for extracting concealed information illustrated in FIG. 4. The storage unit 510 and the controller 520 correspond to the storage unit 410 and the controller 420 of FIG. 4, respectively, and redundant explanations thereof are omitted.

In FIG. 5, the controller 520 may include an inverse transformation module 521, a probability obtaining module 522, and a concealed information extraction module 523.

The inverse transformation module 521 may inversely transform a pixel value of at least one pixel in a group in which the concealed information is inserted. In detail, the inverse transformation module 521 may inversely transform a pixel value by dividing at least one value of Cb and Cr of a pixel p by an insertion factor other than “1.”

Hereinafter, an operation of inversely transforming a pixel value will be described using Equations 3 and 4.

Equation 3 indicates an exemplary embodiment in which a pixel value is inversely transformed. The inverse transformation module 521 may inversely transform the pixel value by dividing the value of cb by the insertion factor used in transforming the pixel value. In Equation 3, INV-MARK({y,cb,cr}) indicates that at least one pixel value among pixel values {y,cb,cr} is inversely transformed.

INV_MARK({y,cb,cr})={y,cb/k,cr} [Equation 3]

Equation 4 indicates that, when inverse transformation is performed on a transformed pixel value, an original pixel value is calculated. That is, INV_MARK(MARK({y,cb,cr})) indicates that a transformed pixel value MARK({y,cb,cr}) is inversely transformed.

INV_MARK(MARK({y,cb,cr}))={y,cb,cr} [Equation 4]

When inverse transformation is performed on a transformed pixel value, a pixel value before transformation may be obtained. Thus, the inversely transformed pixel value may be included in a predetermined color region. On the other hand, when inverse transformation is performed on an untransformed pixel value, the inversely transformed pixel value may not be included in the predetermined color region.

Thus, concealed information may be extracted depending on whether an inversely-transformed pixel value and the pixel value before inverse transformation are included in the predetermined color region, for each of the groups.

In addition, when an inversely-transformed pixel value is included in a predetermined color region, it may be determined that information having a value of “1” is inserted in image data and the pixel value in the group is transformed. Contrary to this, when an inversely-transformed pixel value is not included in a predetermined color region, it may be determined that information having a value of “0” is inserted in image data and the pixel value in the group is not transformed.

The probability obtaining module 522 may obtain a relative probability that a pixel value may be included in a predetermined color region and a relative probability that the inversely-transformed pixel value may be included in the predetermined color region, respectively.

The probability obtaining module 522 may calculate a distance between a pixel value of at least one pixel in a group and a predetermined color region and a distance between the inversely-transformed pixel value and the predetermined color region. The probability obtaining module 522 may obtain relative probabilities that the pixel value and the inversely-transformed pixel value, respectively, may be included in the predetermined color region, by using at least one distance.

The farther a distance between a predetermined color region and a pixel value, the higher a probability that the pixel value may not be included in the predetermined color region. Thus, the probability obtaining module 522 may obtain a relative probability that a pixel value or the inversely-transformed pixel value may be included in a predetermined color region, by using a distance between the pixel value or the inversely-transformed pixel value and the predetermined color region.

In some exemplary embodiments, the probability obtaining module 522 may calculate a distance between a predetermined color region and a value closest to a pixel value of a pixel among values included in the predetermined color region, thereby obtaining a distance between the predetermined color region and the pixel value or the inversely-transformed pixel value.

Hereinafter, an operation of obtaining a distance between a pixel value and a predetermined color region will be described using Equation 5.

Equation 5 indicates an operation of obtaining a distance between a pixel p and a YCbCr region. A distance between pixel values (p_{y},p_{cb},p_{cr}) of the pixel p and an arbitrary value included in the YCbCr region may be represented as max(|p_{y}−y|, |p_{cb}−cb|, |p_{cr}−cr|), and the distance between the pixel p and the YCbCr region may be obtained as the smallest distance between the pixel values of the pixel p and the arbitrary value included in the YCbCr region.

That is, a distance between a value closest to a pixel value of the pixel p among values included in the YCbCr region and the pixel value of the pixel p may be the distance between the pixel p and the YCbCr region.

$$dist ( p , YCbCr ) = {min}_{( y , cb , cr ) ∈ YCbCr} max ( \vert {p}_{y} - y \vert , \vert {p}_{cb} - cb \vert , \vert {p}_{cr} - cr \vert ) \qquad [ Equation 5 ]$$

The operation of obtaining the distance between the pixel p and the YCbCr region may be performed using a method other than Equation 5.

In addition, a relative probability that a pixel value or the inversely-transformed pixel value may be included in a predetermined color region may be obtained using the distance between the pixel p and the YCbCr region.

Hereinafter, an operation of obtaining a relative probability that a pixel value or the inversely-transformed pixel value may be included in a predetermined color region will be described using Equations 6 and 7.

As expressed in Equations 6 and 7, a relative probability may be obtained by using a pixel value included in a GOP as a predetermined group and by obtaining an inverse number of a sum of distances or an inverse number of a multiple obtained by multiplying the inversely-transformed pixel value by a value obtained by adding 1 to the distances according to each of groups.

In Equations 6 and 7, LH(GOP) indicates a relative probability that a pixel value in a GOP may be included in a predetermined color region, and may be obtained using a pixel included in the GOP.

$$LH ( GOP ) = {( {\sum }_{p ∈ GOP} dist ( p , YCbCr ) )}^{- 1} \qquad [ Equation 6 ]$$

$$LH ( GOP ) = {( {\prod }_{p ∈ GOP} ( dist ( p , YCbCr ) + 1 ) )}^{- 1} \qquad [ Equation 7 ]$$

When determining whether a probability that a pixel value in a group may be included in a predetermined color region is higher than a probability that the inversely-transformed pixel value in the group may be included in the predetermined color region, the concealed information extraction module 523 may determine that the pixel value is not transformed and may extract concealed information. Contrary to this, when determining that a probability that an inversely-transformed pixel value in a group may be included in a predetermined color region is higher than a probability that the pixel value in the group may be included in the predetermined color region, the concealed information extraction module 523 may determine that the pixel value in the group is transformed and may extract concealed information. In this case, a likelihood ratio test may be used in determining whether a pixel value is transformed.

Hereinafter, an operation of determining whether a pixel value is transformed using the likelihood ratio test will be described using Equation 8.

$$\{ \begin{matrix}\frac{LH ( GOP )}{LH ( INV\_MARK ( GOP ) )} \geq c , GOP was not marked \\ \frac{LH ( GOP )}{LH ( INV\_MARK ( GOP ) )} < c , GOP was marked\end{matrix} \qquad [ Equation 8 ]$$

In Equation 8, LH(GOP) indicates a relative probability that a pixel value in a group may be included in a predetermined color region, and LH(INV_MARK(GOP)) indicates a relative probability that the inversely-transformed pixel value in the group may be included in the predetermined color region. c may be set as a value that may be used with high precision in determining whether a pixel value in a group is transformed between a type 1 error (probability that may be rejected although hypothesis is true) and a type 2 error (probability that may be accepted true although hypothesis is not true).

In Equation 8, when

$$\frac{LH ( GOP )}{LH ( INV\_MARK ( GOP ) )}$$

is equal to or greater than c, it may be determined that a pixel value in a group is not transformed, and concealed information having a value of “0” may be extracted.

On the other hand, when

$$\frac{LH ( GOP )}{LH ( INV\_MARK ( GOP ) )}$$

is less than c, it may be determined that a pixel value in a group is transformed, and concealed information having a value of “1” may be extracted.

The input unit 530 is a unit for generating a user input signal for controlling or operating the apparatus 500 for extracting concealed information according to user manipulation and may be implemented by various types of input units. For example, the input unit 530 may include one or more key input units, touch input units, gesture input units, or voice input units. A key input unit that generates a signal corresponding to a key according to user manipulation may be a key pad or a keyboard. A touch input unit that senses a user touch operation to recognize an input operation may be a touch pad, a touch screen, or a touch sensor. A gesture input unit that recognizes a user operation, i.e., a designated particular operation, such as an operation of shaking or moving a terminal, an operation of accessing a terminal, an eye flickering operation, or the like, using a particular input signal may include one or more terrestrial magnetic sensors, acceleration sensors, cameras, altimeters, gyro sensors, and proximity sensors.

In FIG. 5, the input unit 530 may extract concealed information by selecting data from which the concealed information is to be extracted, according to user manipulation.

The output unit 540 outputs a user interface for extracting information from data, as illustrated in FIG. 5. For example, the output unit 540 may be one output unit among a liquid crystal display (LCD), a thin film transistor-liquid crystal display (TFT-LCD), a light emitting diode (LED), an organic light emitting diode (OLED), an active matrix organic light emitting diode (AMOLED), a flexible display, and a three-dimensional display.

In FIG. 5, the communication unit 550 may transmit or receive data to or from the apparatus 200 or apparatus 300 for inserting concealed information via wired/wireless communication or infrared ray communication, a network, or the like. Thus, the apparatus 500 for extracting concealed information may receive data in which concealed information is inserted from the apparatus 200 or apparatus 300 for inserting concealed information.

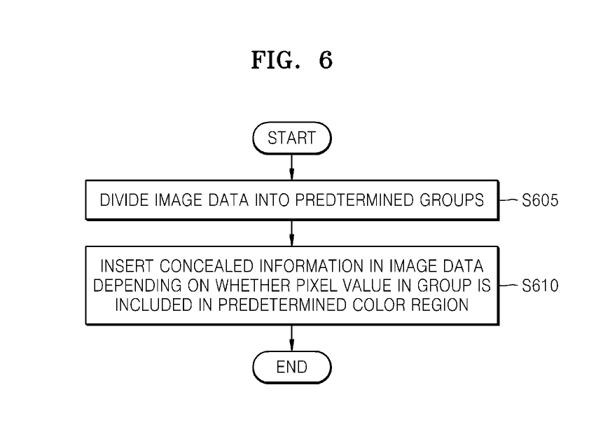

FIG. 6 is a flowchart illustrating a method of inserting concealed information to be later extracted in image data depending on whether a pixel value is included in a predetermined color region, according to an exemplary embodiment.

Referring to FIG. 6, image data in which concealed information is to be inserted is divided into predetermined groups in operation S605. Thus, in some exemplary embodiments, information having a value of “0” or “1” may be inserted in the image data in each group.

In operation S610, it is determined whether to transform at least one pixel included in a group based on the concealed information, and at least one pixel value is transformed according to the determination result in order to insert the concealed information in the image data. In this case, the inserted concealed information may be inserted in the image data depending on whether the transformed pixel value is included in a predetermined color region.

When the image data in which the concealed information is to be inserted is video data, the concealed information may be inserted in the image data in a GOP unit. In this case, in some exemplary embodiments, the concealed information may be inserted in the image data without performing the operation of dividing the image data into groups.

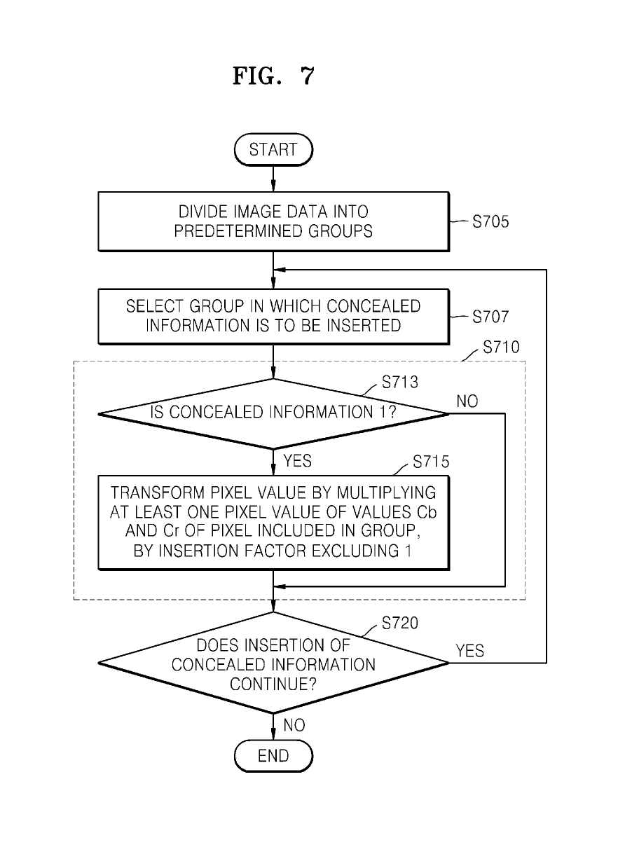

FIG. 7 is a flowchart illustrating a method of inserting concealed information to be extracted later into image data depending on whether a pixel value is included in a predetermined color region, according to an exemplary embodiment.

Referring to FIG. 7, image data in which concealed information is to be inserted may be divided into predetermined groups in operation S705, and a group in which the concealed information is to be inserted may be selected in operation S707. Operation S705 of FIG. 7 may correspond to operation S605 of FIG. 6.

In operation S710, a pixel value in the group is transformed according to the concealed information, thereby inserting the concealed information in the image data. Operation S710 may correspond to operation S610 of FIG. 6.

Operation S710 of inserting the concealed information in the image data may include determining whether the concealed information has a value of “1” or “0” (S713) and transforming the pixel value by multiplying at least one pixel value of values Cb and Cr of a pixel p included in the group in which the concealed information is to be inserted by an insertion factor other than 1 (S715).

When the concealed information has a value of “1,” operation S715 is performed, and when the concealed information has a value of “0”, operation S715 of transforming the pixel value may not be performed.

It is determined whether insertion of the concealed information continues (S720), thereby determining whether to insert the concealed information into another group of the image data.

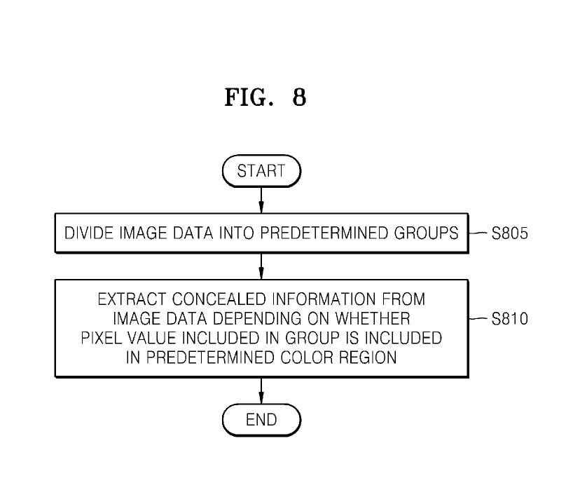

FIG. 8 is a flowchart illustrating a method of extracting concealed information inserted in image data depending on whether a pixel value is included in a predetermined color region, according to an exemplary embodiment.

Referring to FIG. 8, image data is divided into predetermined groups in operation S805, and concealed information may be extracted according to groups depending on whether a pixel value of at least one pixel included in a group from which the concealed information is to be extracted, is included in a predetermined color region in operation S810.

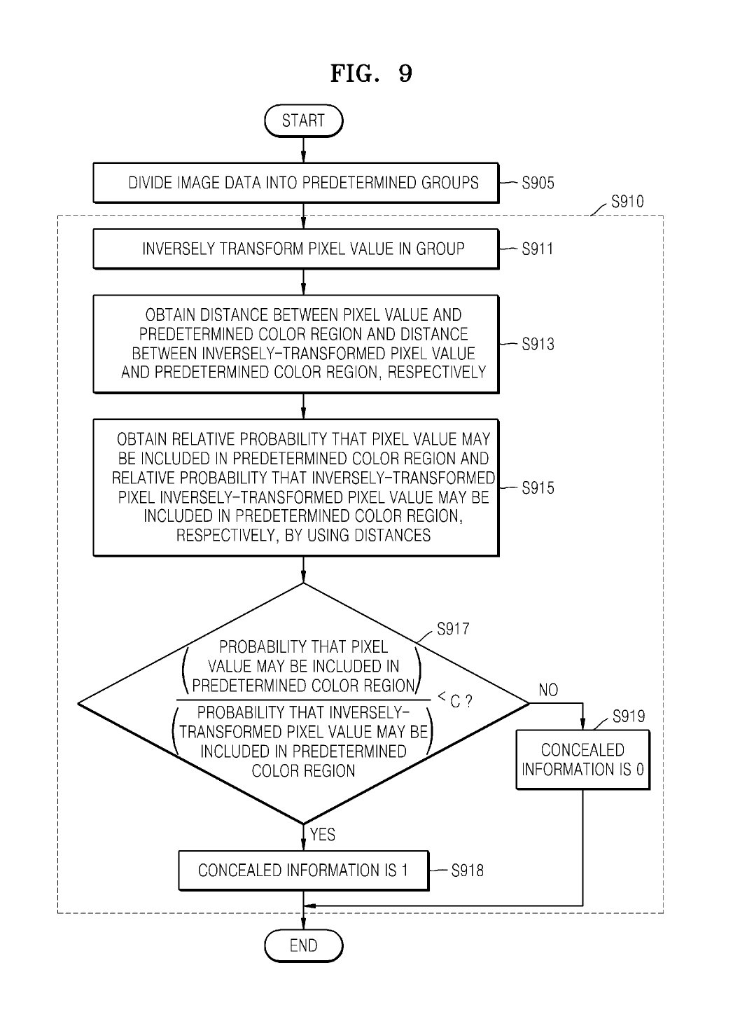

FIG. 9 is a flowchart illustrating a method of extracting concealed information inserted in image data depending on whether a pixel value is included in a predetermined color region, according to another exemplary embodiment.

Referring to FIG. 9, image data is divided into predetermined groups in operation S905, and concealed information may be extracted according to groups depending on whether a pixel value of at least one pixel included in a group from which the concealed information is to be extracted is included in a predetermined color region in operation S910. Operations S905 and S910 may correspond to operations S805 and S810 of FIG. 8, respectively.

Operation S910 of extracting the concealed information from the image data may include inversely transforming the pixel value of the pixel in the group from which the concealed information is to be extracted (S911), obtaining a distance between the pixel value and the predetermined color region and a distance between the inversely-transformed pixel value and the predetermined color region (S913), obtaining a relative probability that the pixel value in the group may be included in the predetermined color region and a relative probability that the inversely-transformed pixel value may be included in the predetermined color region by using the distances (S915), and extracting the concealed information inserted in the group of the image data by comparing the obtained probabilities (S917 to S919).

In operation S917, it may be determined whether the pixel value is transformed by comparing a ratio of the probability that the pixel value may be included in the predetermined color region with respect to the probability that the inversely-transformed pixel value may be included in the predetermined color region with a predetermined constant c. In this case, the predetermined constant c may be determined as a number that may be used in extracting the concealed information with high precision.

If in operation S917, it is determined that the ratio is greater than c, in operation S919, it is determined whether the concealed information has a value of “0.” If in operation S917, it is determined that the ratio is less than c, in operation S918, it is determined whether the concealed information has a value of “1.”

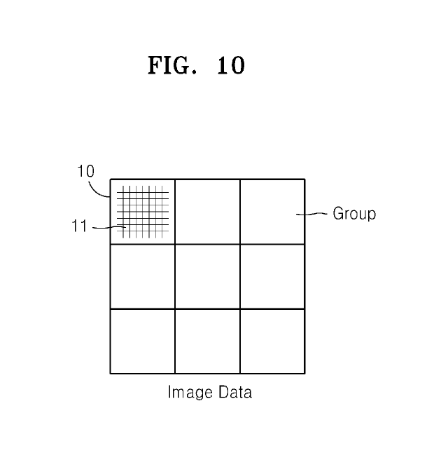

FIG. 10 is a flowchart illustrating a method of inserting or extracting concealed information in or from image data depending on whether a pixel value is included in a predetermined color region, according to another embodiment of the present invention.

Referring to FIG. 10, in the method of inserting concealed information to be later extracted in image data according to the present embodiment, image data may be divided into predetermined groups, and concealed information of 0 or 1 may be inserted in the image data in units of a group. In addition, the concealed information of 0 or 1 may be inserted in a group 10 by transforming a pixel value of at least one pixel 11 in the group 10 according to the present embodiment.

In this case, the concealed information of 0 or 1 may be inserted in the group 10 by transforming pixel values of all pixels included in the group 10 or by transforming a pixel value of a part selected from pixels included in the group 10 according to predetermined rules. For example, a pixel value of at least one pixel in odd-numbered lines of the group 10 may be transformed.

On the other hand, in the method of extracting concealed information from image data according to the present embodiment, concealed information of 0 or 1 may be extracted in units of predetermined groups that are divided by using the method of inserting concealed information to be later extracted in image data. In addition, the concealed information of 0 or 1 inserted in a group 10 may be extracted from the image data by determining whether a pixel value of at least one pixel 11 included in the group 10.

In this case, the concealed information of 0 or 1 inserted in one group 10 may be extracted from the image data by determining whether pixel values of all pixels included in the group 10 are transmitted, or by determining whether a pixel value of a part selected from pixels included in the group 10 according to predetermined rules, as in the method of inserting concealed information to be later extracted in the image data. For example, it may be determined whether a pixel value of at least one pixel in odd-numbered lines of the group 10 is transformed.

The exemplary embodiments can also be embodied as computer (including all devices having the function of image processing) readable codes on a computer readable recording medium. The computer readable recording medium is any data storage device that can store data that can be thereafter read by a computer system. Examples of the computer readable recording medium include read-only memory (ROM), random-access memory (RAM), CD-ROMs, magnetic tapes, floppy disks, optical data storage devices, etc.

While the exemplary embodiments have been particularly shown and described with reference to exemplary embodiments thereof, it will be understood by those skilled in the art that various changes in form and details may be made therein without departing from the spirit and scope of the exemplary embodiments as defined by the appended claims. The exemplary embodiments should be considered in descriptive sense only and not for purposes of limitation. Therefore, the scope of the exemplary embodiments are defined not by the detailed description but by the appended claims, and all differences within the scope will be construed as being included in the exemplary embodiments.

What is claimed is:

1. A method of inserting concealed information in image data, the method comprising:
dividing the image data into predetermined groups;
determining whether to transform at least one pixel value included in each of the predetermined groups, according to the concealed information;
transforming the at least one pixel value according to a result of the determining; and
inserting the concealed information in the image data depending on whether the transformed pixel value is included in a predetermined color region.

2. The method of claim 1, wherein the inserting the concealed information in the image data comprises inserting 0 or 1 in the image data depending on whether the at least one pixel value is transformed for each of the predetermined groups.

3. The method of claim 1, wherein it is determined whether the transformed at least one pixel value is included in the predetermined color region based on a probability that the at least one pixel value is included in the predetermined color region.

4. The method of claim 3, wherein the probability that the at least one pixel value is included in the predetermined color region is obtained using a distance between the transformed pixel value and the predetermined color region.

5. A method of extracting concealed information from image data, the method comprising:
dividing the image data into predetermined groups; and
extracting concealed information for each of the predetermined groups depending on whether a pixel value of at least one pixel value included in each of the predetermined groups from which the concealed information is to be extracted is included in a predetermined color region.

6. The method of claim 5, wherein it is determined whether the at least one pixel value is included in the predetermined color region based on a probability that the at least one pixel value is included in the predetermined color region.

7. The method of claim 6, wherein the probability is obtained based on a distance between the at least one pixel value and the predetermined color region.

8. The method of claim 5, wherein the extracting the concealed information comprises:
inversely transforming the at least one pixel value; and
extracting the concealed information for each of the predetermined groups depending on whether the at least one pixel value and the inversely-transformed pixel value are included in the predetermined color region.

9. The method of claim 8, wherein the extracting the concealed information comprises:
obtaining a first probability that the at least one pixel value is included in the predetermined color region and a second probability that the inversely-transformed pixel value is included in the predetermined color region for each of the predetermined groups; and
extracting the concealed information for each of the predetermined groups based on a result of comparing of the first probability and the second probability.

10. The method of claim 9, wherein the obtaining the first probability and the second probability comprises obtaining the first probability and the second probability by using at least one distance between the pixel value of the at least one pixel in each of the predetermined groups or the inversely-transformed pixel value and the predetermined color region.

11. The method of claim 10, wherein the obtaining the first probability and the second probability comprises obtaining the first probability and the second probability by obtaining an inverse number of a sum of the at least one distance or an inverse number of a multiple obtained by multiplying the inversely-transformed pixel value by a value obtained by adding 1 to the at least one distance for each of the predetermined groups.

12. The method of claim 9, wherein the extracting the concealed information comprises determining whether the pixel value is transformed according to the result of comparing the first probability and the second probability and extracting the concealed information for each of the predetermined groups based on the determination.

13. An apparatus for inserting concealed information in image data, the apparatus comprising:
a storage unit which stores the image data; and
a controller which divides the image data into predetermined groups, determines whether to transform at least one pixel value included in each of the predetermined groups according to concealed information, and transforms the at least one pixel value based on a result of the determination to insert the concealed information in the image data,
wherein the concealed information is inserted in the image data depending on whether the transformed pixel value is included in a predetermined color region.

14. The apparatus of claim 13, wherein the controller comprises:
a bit transformation module which transforms the concealed information into bit information; and
a pixel value transformation module which divides the image data into the predetermined groups, determines whether to transform the at least one pixel value included in each of the predetermined groups according to the concealed information, and transforms the at least one pixel value based on the determination to insert the concealed information in the image data.

15. The apparatus of claim 14, wherein the pixel value transformation module inserts 0 or 1 in the image data depending on whether the at least one pixel value is transformed for each of the predetermined groups.

16. The apparatus of claim 14, wherein the pixel value transformation module determines whether the transformed pixel value is included in the predetermined color region based on a probability that the transformed pixel value is included in the predetermined color region.

17. The apparatus of claim 16, wherein the pixel value transformation module obtains the probability by using a distance between the transformed pixel value and the predetermined color region.

18. An apparatus for extracting concealed information from image data, the apparatus comprising:
a storage unit which stores the image data; and
a controller which divides the image data into predetermined groups and extracts concealed information according to each of the predetermined groups depending on whether a pixel value of at least one pixel included in each of the predetermined groups from which the concealed information is to be extracted is included in a predetermined color region.

19. The apparatus of claim 18, wherein the controller further comprises
a concealed information extraction module which extracts the concealed information for each of the predetermined groups depending on whether the pixel value of the at least one pixel included in each of the predetermined groups from which the concealed information is to be extracted is included in the predetermined color region.

20. The apparatus of claim 19, wherein the concealed information extraction module determines whether the pixel value is included in the predetermined color region based on a first probability that the pixel value is included in the predetermined color region.

21. The apparatus of claim 20, wherein the concealed information extraction module obtains the first probability based on a distance between the pixel value and the predetermined color region.

22. The apparatus of claim 19, wherein the controller further comprises an inverse transformation module which inversely transforms the pixel value, and
wherein the concealed information extraction module extracts the concealed information according to each of the predetermined groups depending on whether the at least one pixel value and the inversely-transformed pixel value are included in the predetermined color region according to each of the predetermined groups.

23. The apparatus of claim 22, wherein the controller further comprises
a probability obtaining module which obtains a probability that the pixel value is included in the predetermined color region and a second probability that the inversely-transformed pixel value is included in the predetermined color region for each of the predetermined groups, and
the concealed information extraction module extracts the concealed information according to each of the predetermined groups based on a result of comparing the first probability and the second probability.

24. The apparatus of claim 23, wherein the probability obtaining module obtains the first probability and the second probability using a distance between the pixel value of the at least one pixel in each of the predetermined groups or the inversely-transformed pixel value and the predetermined color region.

25. The apparatus of claim 23, wherein the concealed information extraction module determines whether the pixel value is transformed based on the result of comparing of the first probability that the pixel value is included in the predetermined color region with the second probability that the inversely-transformed pixel value is included in the predetermined color region, and extracts the concealed information for each of the predetermined groups based on the determination.

26. The apparatus of claim 23, wherein the probability obtaining module obtains the first probability and the second probability by obtaining an inverse number of a sum of at least one distance or an inverse number of a multiple obtained by multiplying the inversely-transformed pixel value by a value obtained by adding 1 to the at least one distance for each of the predetermined groups.

27. A computer readable recording medium having recorded thereon a program for executing the method of claim 1.
